(19) United States
(12) Patent Application Publication
(10) Pub. No.: US 2010/0173507 A1
(43) Pub. Date: Jul. 8, 2010

(54) ELECTRICAL CONNECTOR HAVING MULTIPLE GROUND PLANES

(75) Inventors: Brian VICICH, Prospect, KY (US); John MONGOLD, Middletown, PA (US); Chad FAITH, Corydon, IN (US); James NADOLNY, Mechanicsburg, PA (US)

Correspondence Address: SAMTEC INCORPORATED;C/O KEATING & BENNETT, LLP, 1800 Alexander Bell Drive, SUITE 200, Reston, VA, 20191, US

(73) Assignee: Samtec, Inc., New Albany, IN (US)

(21) Appl. No.: 12/349,767

(22) Filed: Jan. 7, 2009

(51) Int. Cl. H01R 12/00; H01R 13/648

(52) U.S. Cl. 439/82; 439/108

(57) ABSTRACT

An electrical connector includes a first row of contacts, a second row of contacts, a first ground plane, a second ground plane, each extending in a first direction. The first row of contacts is located closer to the first ground plane than any other ground plane in the electrical connector. The second row of contacts is located closer to the second ground plane than any other ground plane in the electrical connector. The first row of contacts, the second row of contacts, the first ground plane, and the second ground plane oppose each other such that the first row of contacts, the second row of contacts, the first ground plane, and the second ground plane are arranged with respect to each other in a second direction perpendicular or substantially perpendicular to the first direction.

### BACKGROUND OF THE INVENTION

1. Field of the Invention

The present invention relates to electrical connectors. More specifically, the present invention relates to electrical connectors having multiple ground planes.

2. Description of the Related Art

It is well known to use electrical connectors to place two devices, e.g. printed circuit boards, in electrical communication which each other. As devices get smaller, the number of electrical connections per unit of area increases. One of the problems with increasing the number of electrical connections per unit of area is that the cross-talk between electrical connections increases.

It is known to provide ground or power planes between rows of signal contacts and to ground the electrical contacts between the signal contacts in order to reduce the cross-talk between the signal contacts. One of the problems with the technique of adding ground or power planes and the technique of grounding the electrical contacts is that these techniques use space in which signal contacts could be provided, i.e. these techniques decrease the possible number of electrical connections per unit of area. Another problem with these techniques is that they add cost to the electrical connector. Known examples of this type of electrical connectors are shown in U.S. Pat. Nos. 6,739,884 and 7,121,849.

### SUMMARY OF THE INVENTION

To overcome the problems described above, preferred embodiments of the present invention provide connectors that solve at least one of the problems described above.

According to a preferred embodiment of the present invention, an electrical connector includes a first row of contacts extending in a first direction, a second row of contacts extending in the first direction, a first ground plane extending in the first direction, a second ground plane extending in the first direction. The first row of contacts is located closer to the first ground plane than any other ground plane in the electrical connector. The second row of contacts is located closer to the second ground plane than any other ground plane in the electrical connector. The first row of contacts, the second row of contacts, the first ground plane, and the second ground plane oppose each other such that the first row of contacts, the second row of contacts, the first ground plane, and the second ground plane are arranged with respect to each other in a second direction perpendicular or substantially perpendicular to the first direction.

The electrical connector preferably further includes a shroud that is arranged to surround an interface between the electrical connector and another electrical connector when the electrical connector is mated with the another electrical connector. The electrical connector preferably further includes at least one electronic component. The electrical connector preferably further includes at least one capacitor connected between the first ground plane and the second ground plane.

The electrical connector preferably further includes at least one power plane. The electrical connector preferably further includes a first power plane and a second power plane, where power with a first voltage is transmitted through the first power plane and where power with a second voltage, different from the first voltage, is transmitted through the second power plane.

The electrical connector preferably further includes a coaxial connector. Each of the first ground plane and the second ground plane preferably includes at least one tongue that is arranged to make a mechanical and an electrical connection with a corresponding ground plane of another electrical connector when the electrical connector is mated with the another electrical connector. The first row of contacts and the second row of contacts are preferably spaced apart from the first ground plane and the second ground plane, respectively, by about 0.016 inches to about 0.020 inches, for example.

Preferably, the first row of contacts is located between the first ground plane and an exterior of the electrical connector, and the second row of contacts is located between the second ground plane and the exterior of the electrical connector. Preferably, the first ground plane is located between the first row of contacts and an exterior of the electrical connector, and the second ground plane is located between the second row of contacts and the exterior of the electrical connector. Preferably, each of the first row of contacts and the second row of contacts includes a first bank of contacts and a second bank of contacts, and each of the first and the second ground planes includes a first divided ground plane and a second divided ground plane.

The electrical connector preferably further includes at least one chamfered protrusion that is arranged to engage with a slot of another connector so that the electrical connector zippers with the another electrical connector when the electrical connector is mated with the another electrical connector. The electrical connector preferably further includes a slot that is arranged to engage with at least one chamfered protrusion of another connector so that the electrical connector zippers with the another electrical connector when the electrical connector is mated with the another electrical connector.

According to a preferred embodiment of the present invention, a circuit board includes a first row of contact pads that extends in a first direction and that is arranged to be connected to a corresponding first row of contacts of an electrical connector, a second row of contact pads that extends in the first direction and that is arranged to be connected to a corresponding second row of contacts of an electrical connector, a first ground plane pad that continuously extends in the first direction along the first row of contacts pads and that is arranged to be connected to a corresponding first ground plane of an electrical connector, and a second ground plane pad that continuously extends in the first direction along the second row of contacts pads and that is arranged to be connected to a corresponding second ground plane of an electrical connector. The first row of contact pads is located closer to the first ground plane pad than any other ground plane pad in the circuit board. The second row of contact pads is located closer to the second ground plane pad than any other ground plane pad in the circuit board. The first row of contact pads, the second row of contact pads, the first ground plane pad, and the second ground plane pad oppose each other such that the first row of contact pads, the second row of contact pads, the first ground plane pad, and the second ground plane pad are arranged with respect to each other in a second direction perpendicular or substantially perpendicular to the first direction.

The circuit board preferably further includes at least one power plane pad that continuously extends in the first direction and that is arranged to be connected to a corresponding power plane of an electrical connector. The circuit board preferably further includes at least one coaxial connector that is arranged to be connected to at least one corresponding coaxial connector of an electrical connector.

The first row of contact pads and the second row of contact pads are preferably spaced apart from the first ground plane and the second ground plane, respectively, by about 0.016 inches to about 0.020 inches, for example. Preferably, the first ground plane pad is located between the first row of contact pads and the second row of contact pads, and the second ground plane pad is located between the first row of contact pads and the second row of contact pads. Preferably, each of the first row of contact pads and the second row of contact pads includes a first bank of contact pads and a second bank of contact pads, and each of the first ground plane pad and the second ground plane pad includes a first divided ground plane pad and a second divided ground plane pad.

Other features, elements, characteristics and advantages of the present invention will become more apparent from the following detailed description of preferred embodiments of the present invention with reference to the attached drawings.

### BRIEF DESCRIPTION OF THE DRAWINGS

FIG. 1A is a perspective top view of a female connector according to a preferred embodiment of the present invention.

FIG. 1B is another perspective top view of a female connector according to a preferred embodiment of the present invention.

FIG. 1C is a perspective bottom view of a female connector according to a preferred embodiment of the present invention.

FIG. 1D is a close-up partial view of a female connector according to a preferred embodiment of the present invention.

FIG. 2A is a perspective top view of a male connector according to a preferred embodiment of the present invention.

FIG. 2B is another perspective top view of a male connector according to a preferred embodiment of the present invention.

FIG. 2C is a perspective bottom view of a male connector according to a preferred embodiment of the present invention.

FIG. 2D is a close-up partial view of a male connector according to a preferred embodiment of the present invention.

FIGS. 3A-3C are cross-sectional views of various preferred embodiments of the present invention.

FIGS. 4A-4E are top plan views of printed circuit boards having footprints according to preferred embodiments of the present invention.

FIG. 5A is a bottom perspective view of the female connector according to a preferred embodiment of the present invention.

FIG. 5B is a bottom perspective view of the male connector according to a preferred embodiment of the present invention.

FIG. 5C is a sectional view of the female connector according to a preferred embodiment of the present invention.

FIG. 6A is a top perspective view of female connector according to a preferred embodiment of the present invention.

FIG. 6B is a bottom perspective view of female connector according to a preferred embodiment of the present invention.

FIG. 6C is a top perspective view of male connector according to a preferred embodiment of the present invention.

FIG. 6D is a bottom perspective view of male connector according to a preferred embodiment of the present invention.

FIGS. 7A-7H are various views of ground planes according to preferred embodiments of the present invention.

### DETAILED DESCRIPTION OF PREFERRED EMBODIMENTS

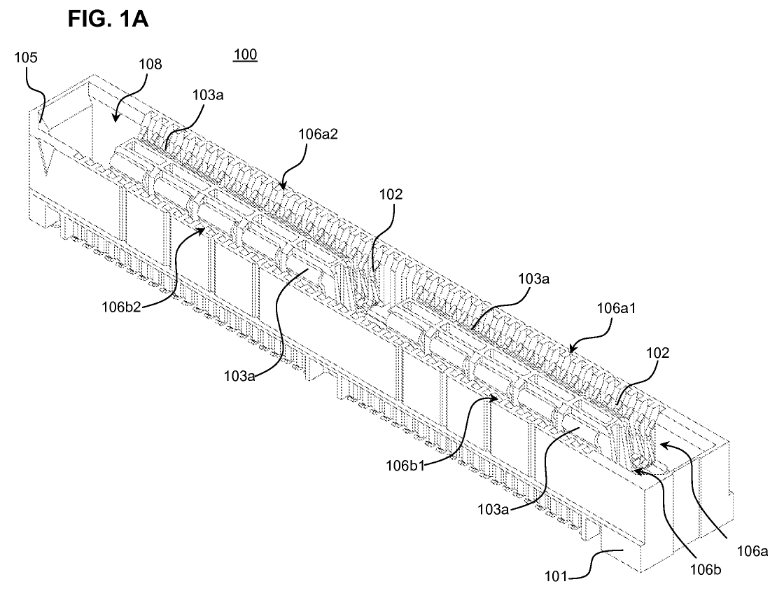

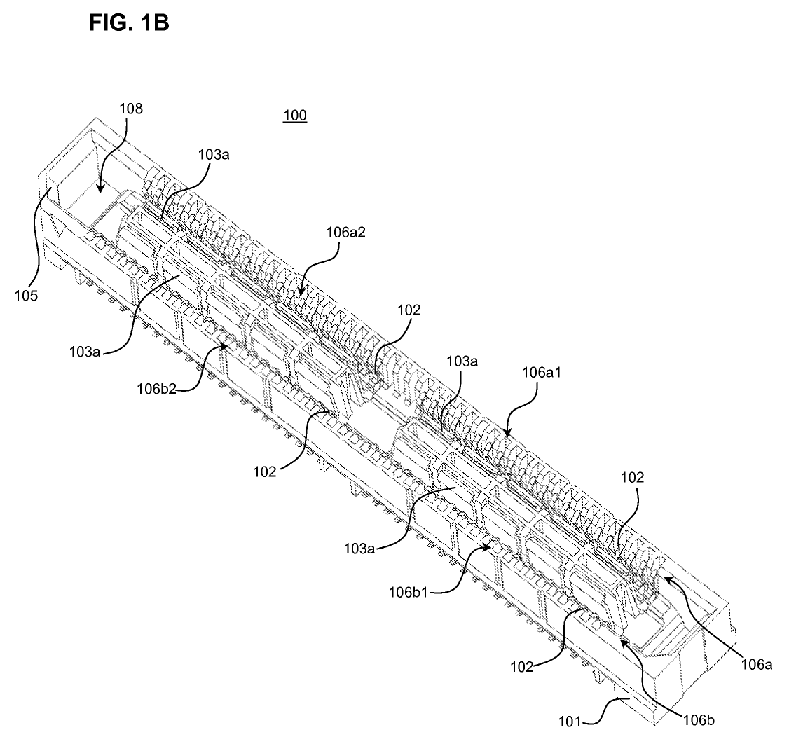

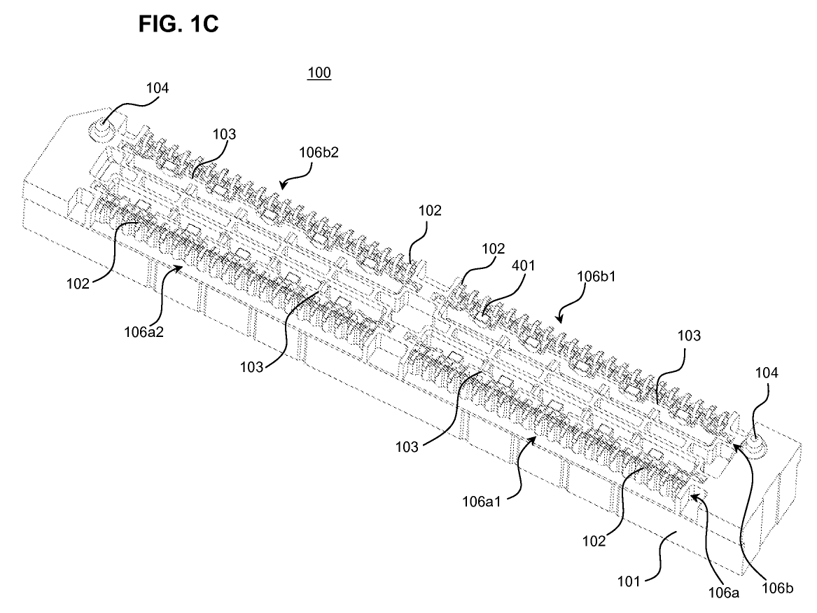

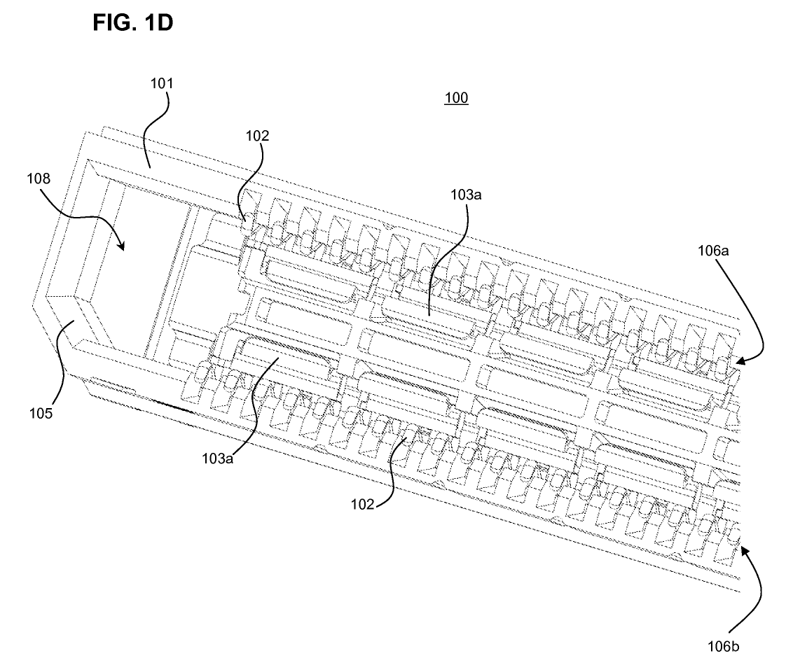

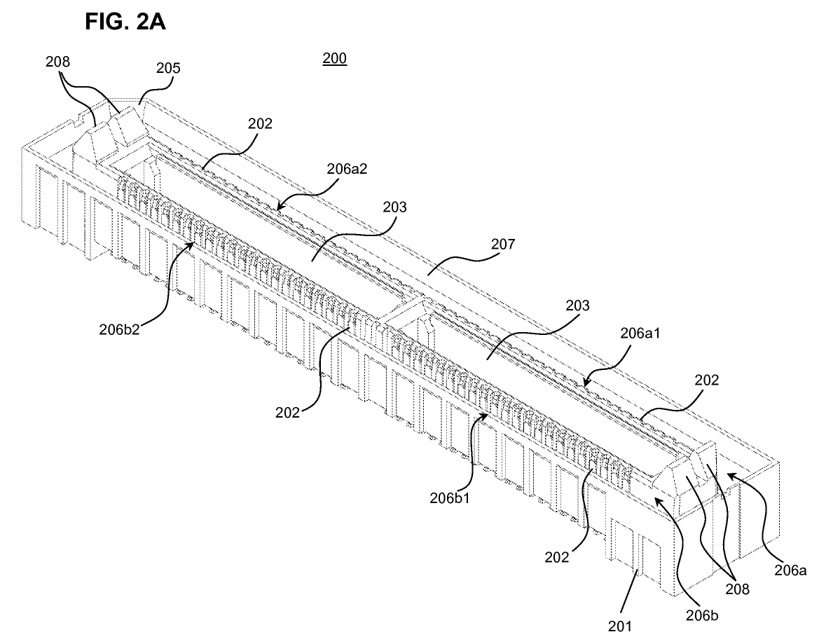

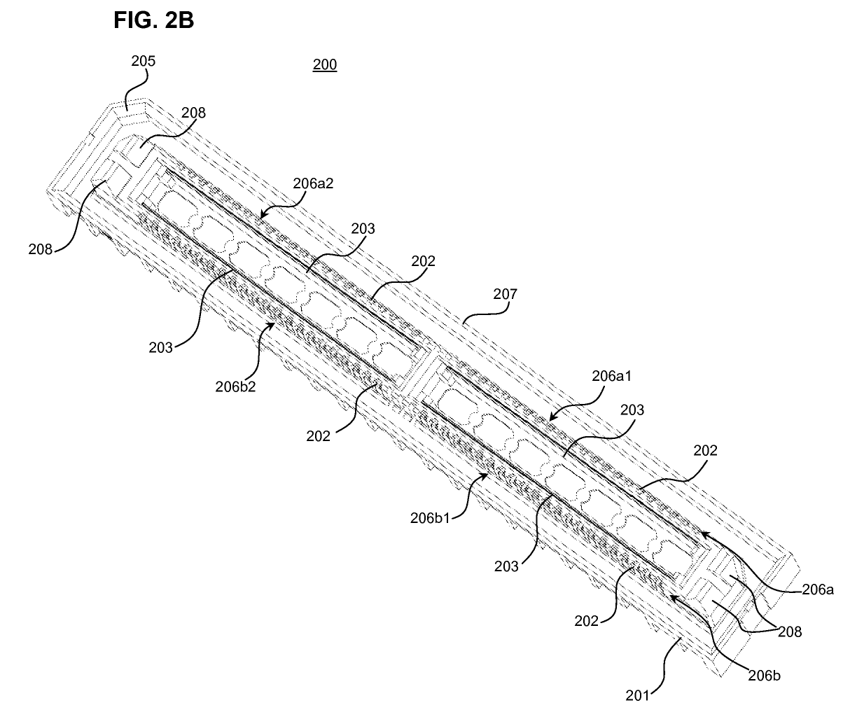

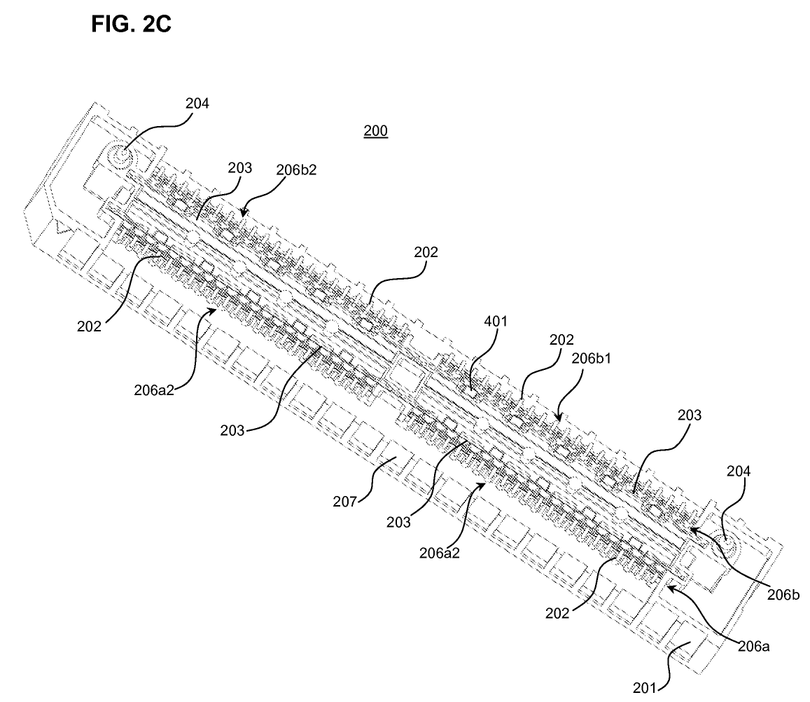

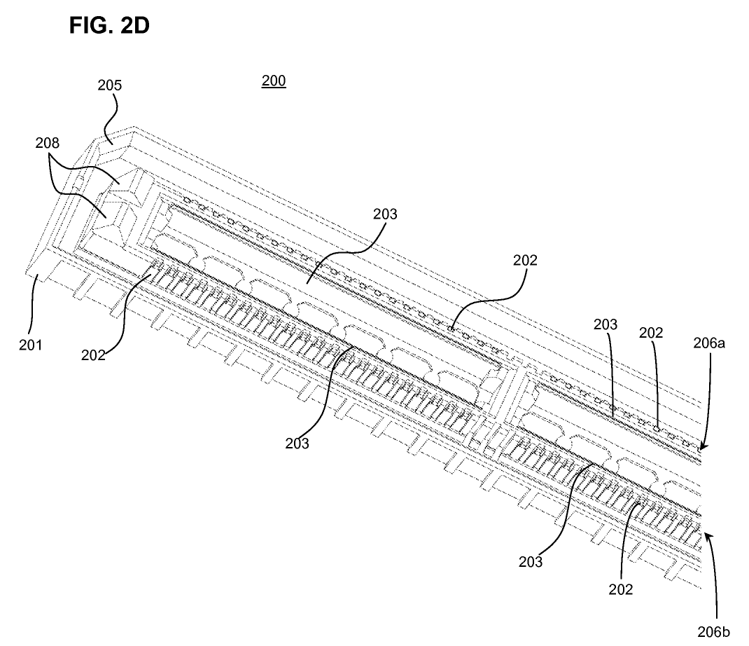

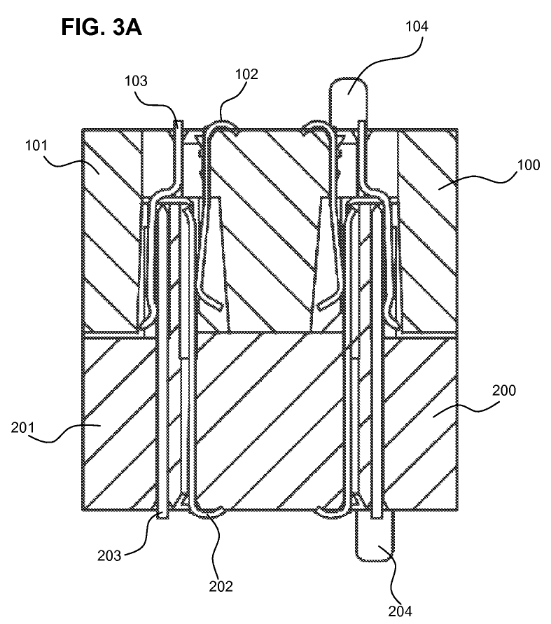

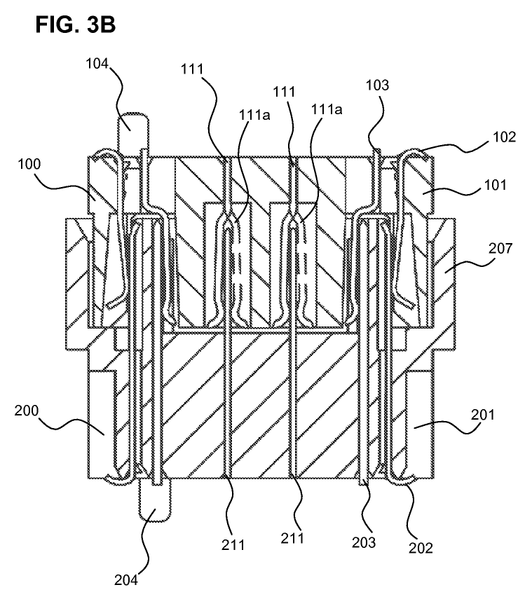

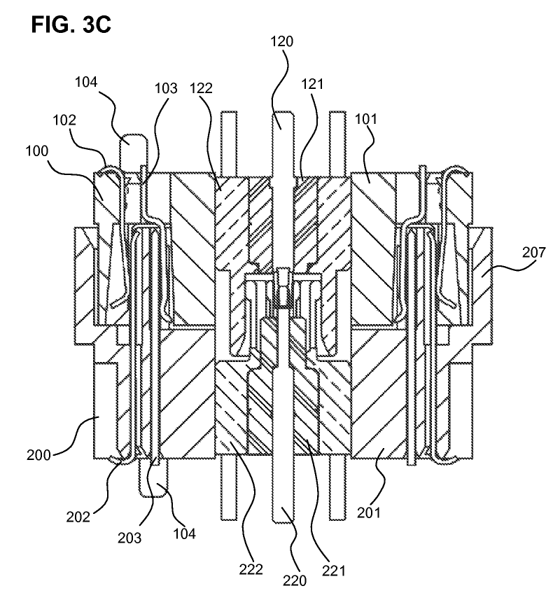

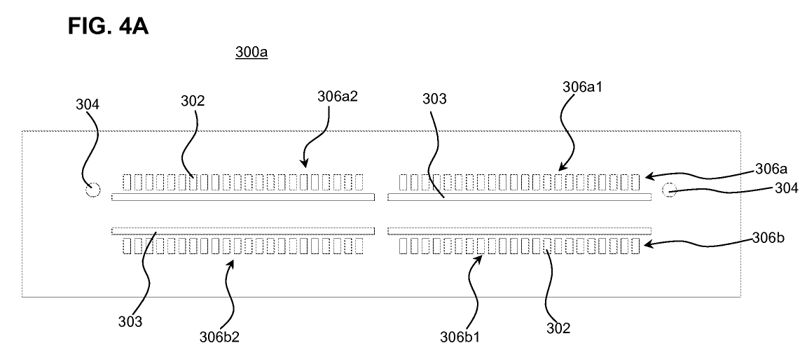

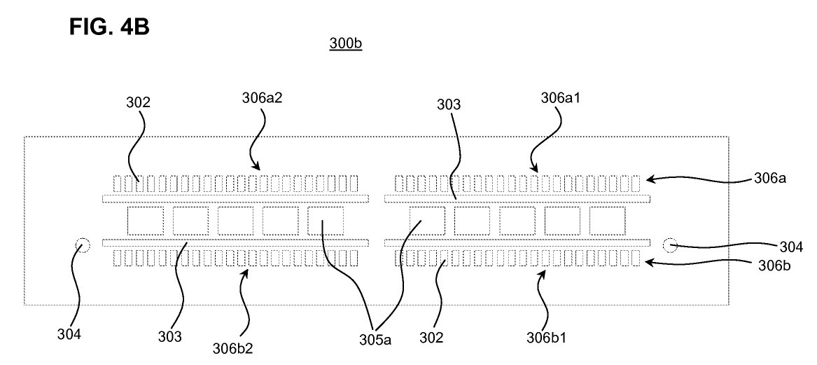

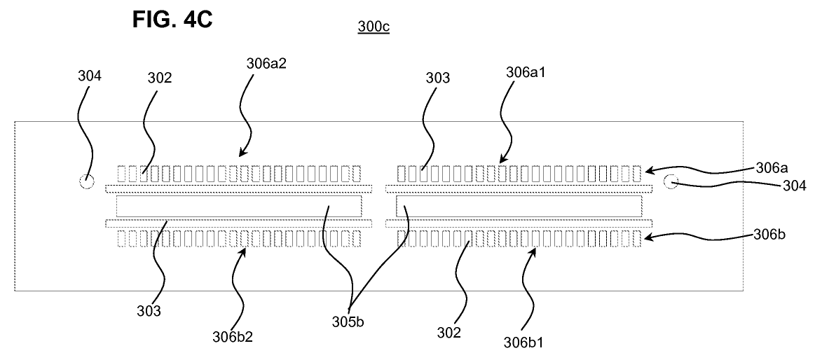

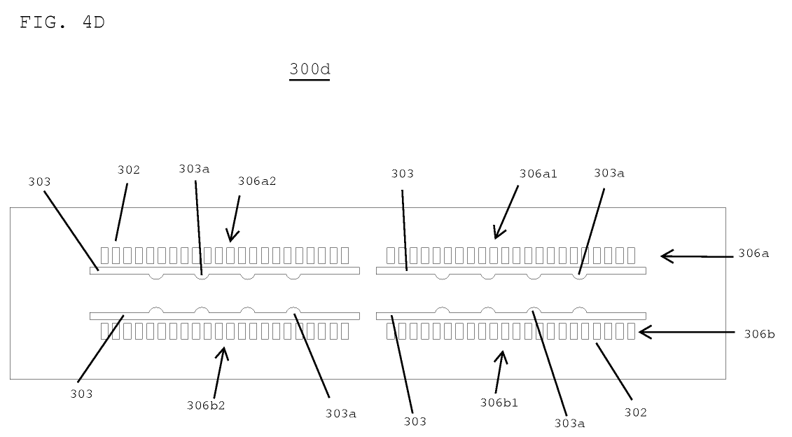

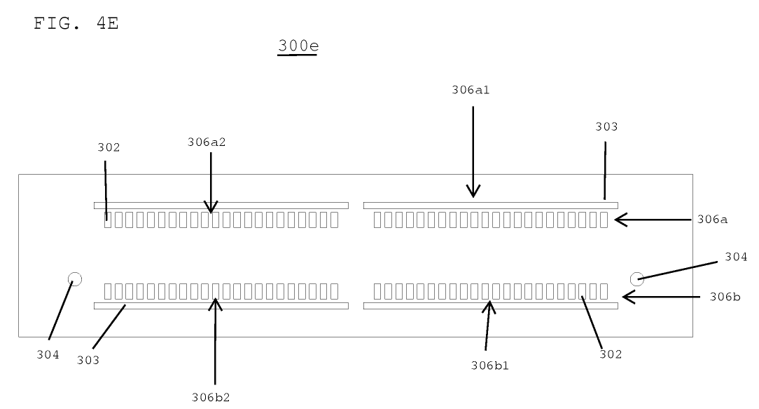

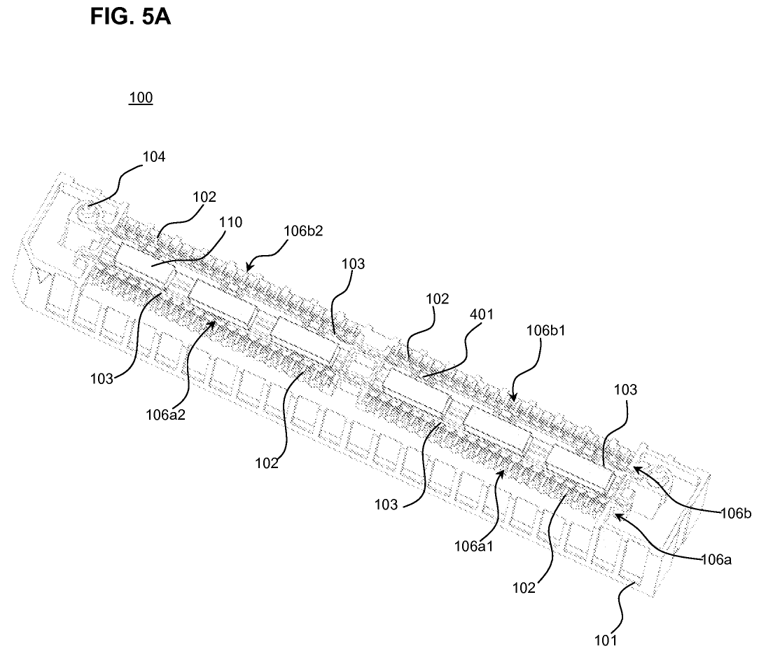

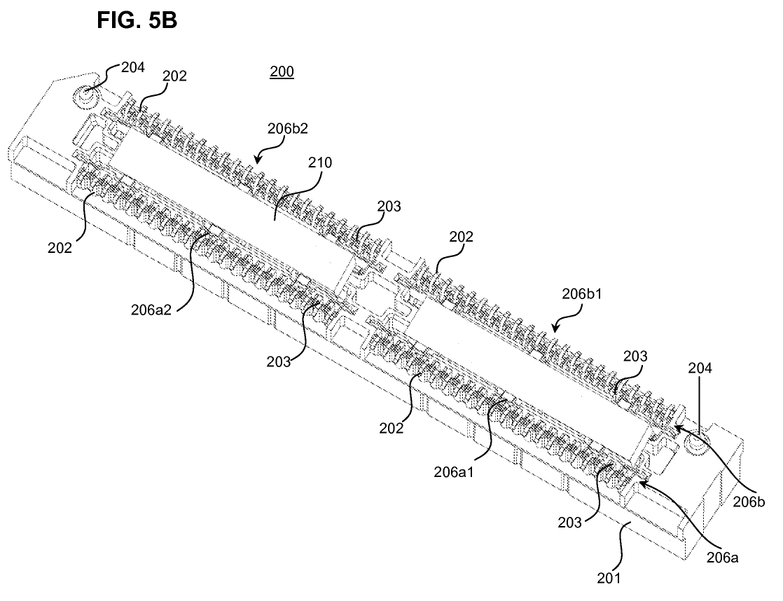

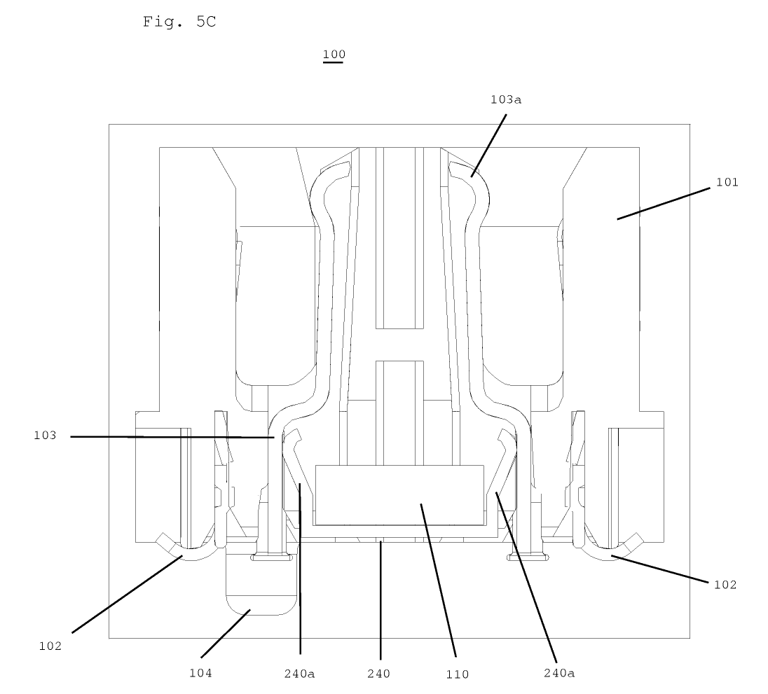

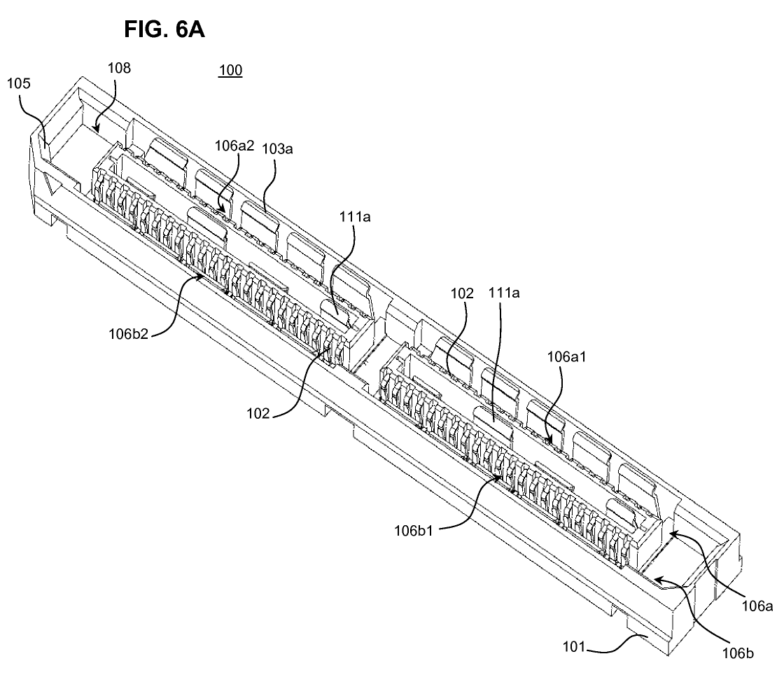

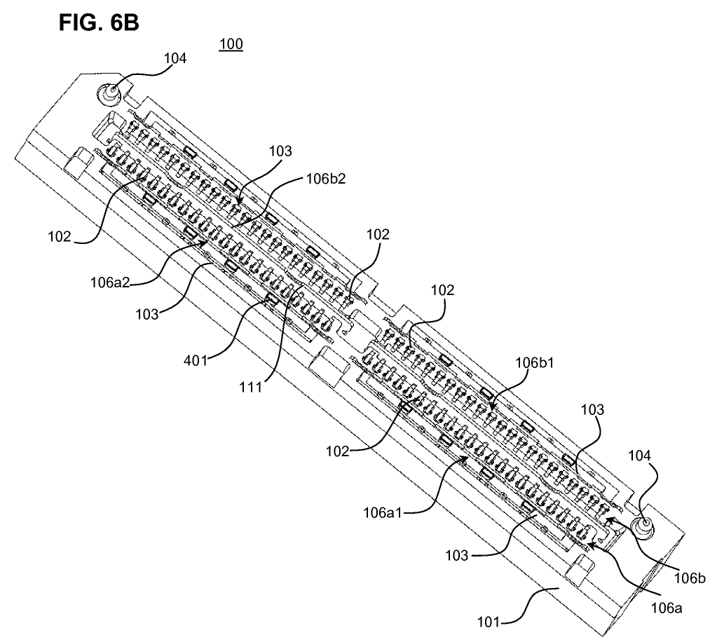

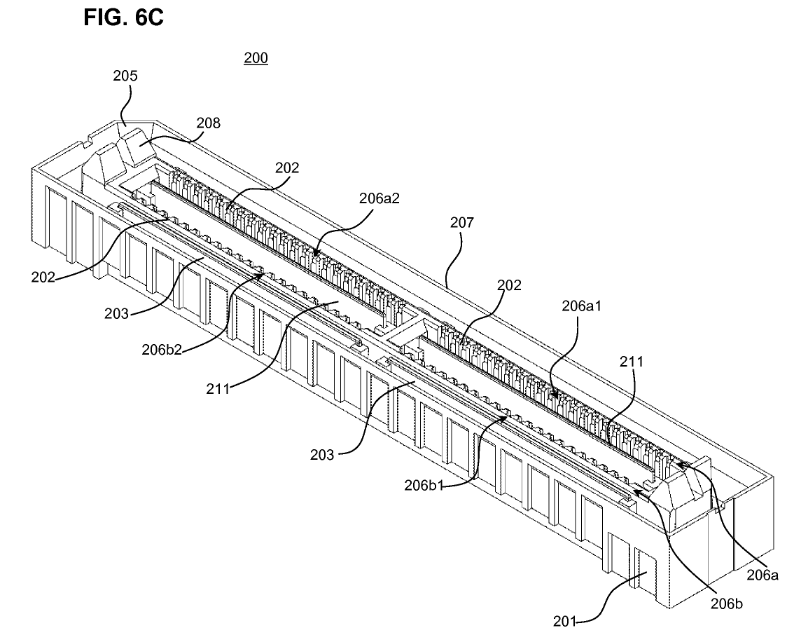

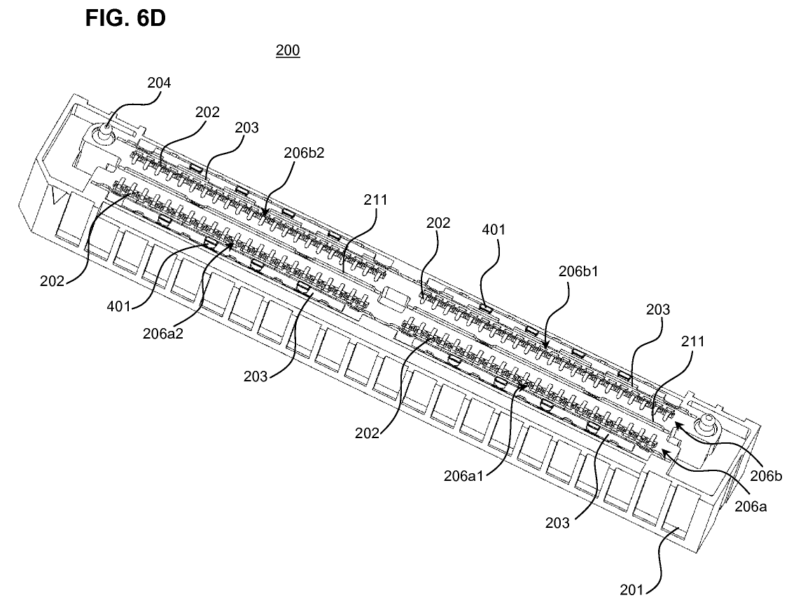

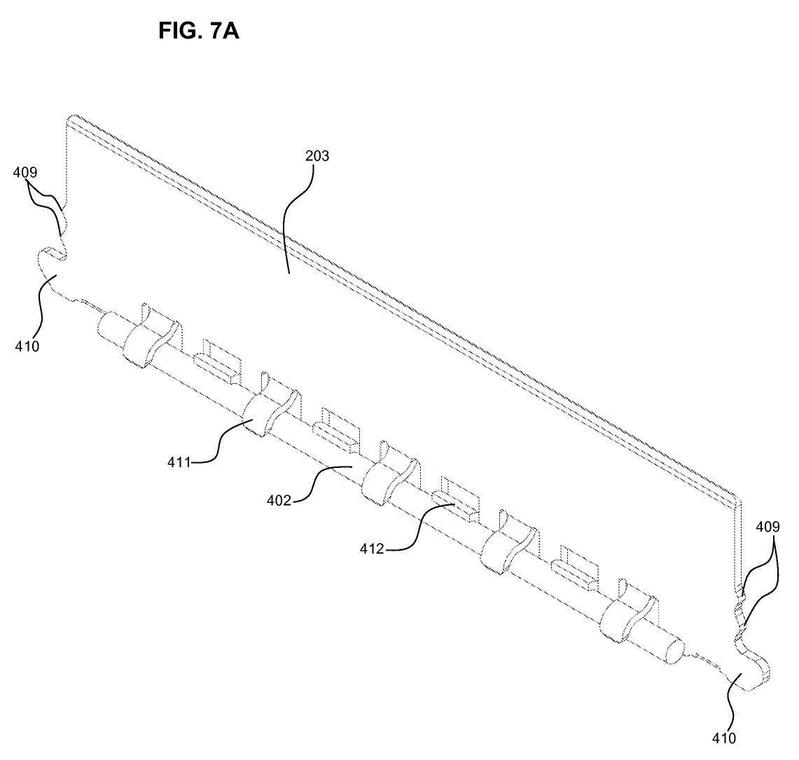

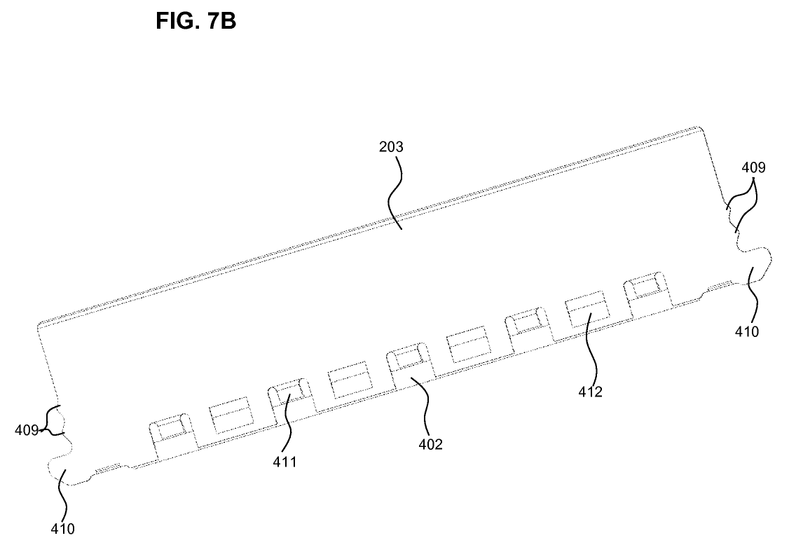

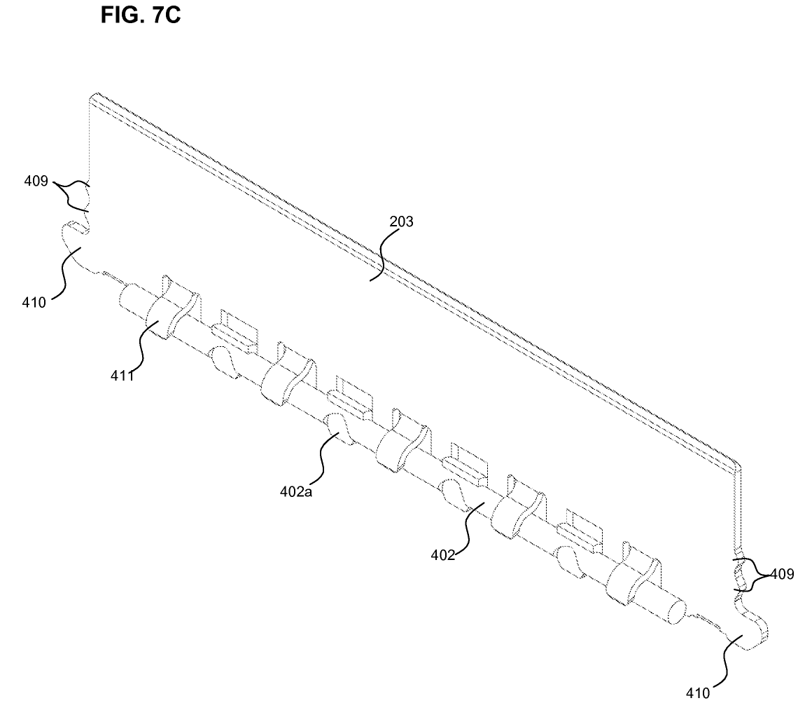

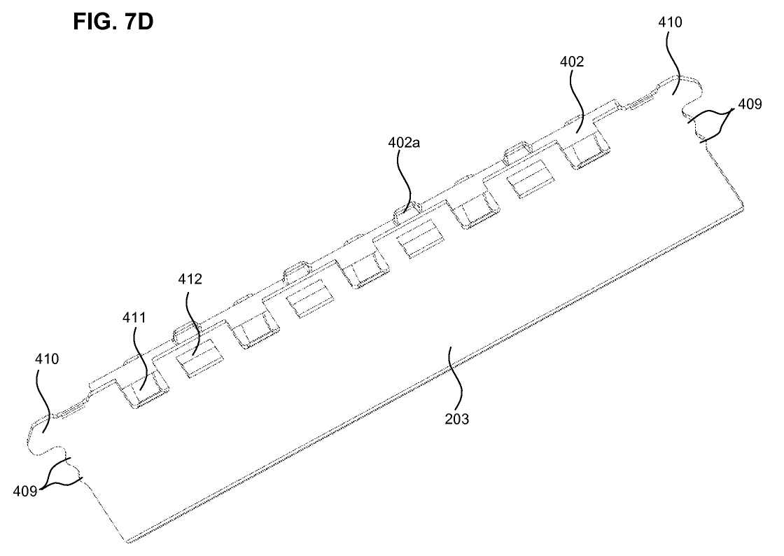

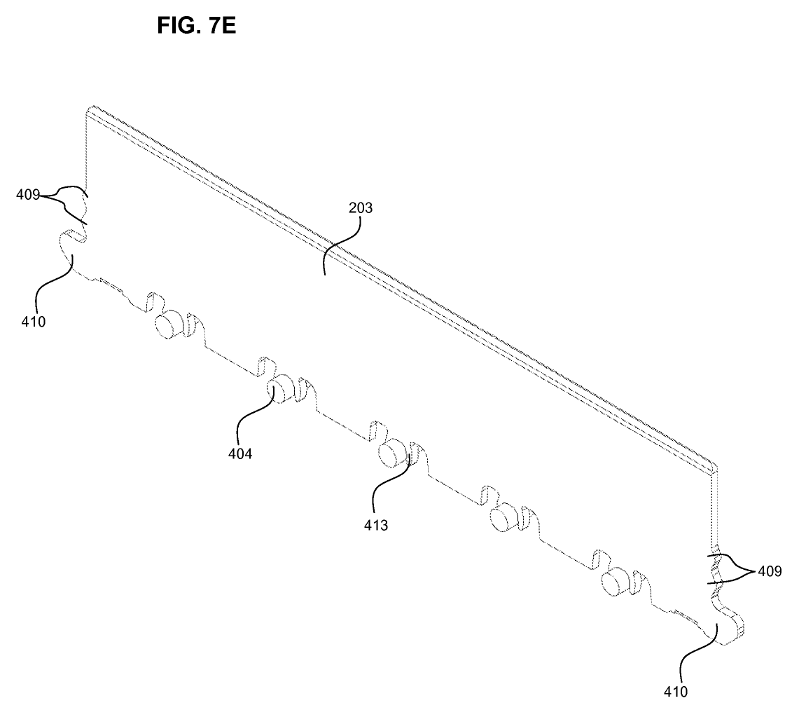

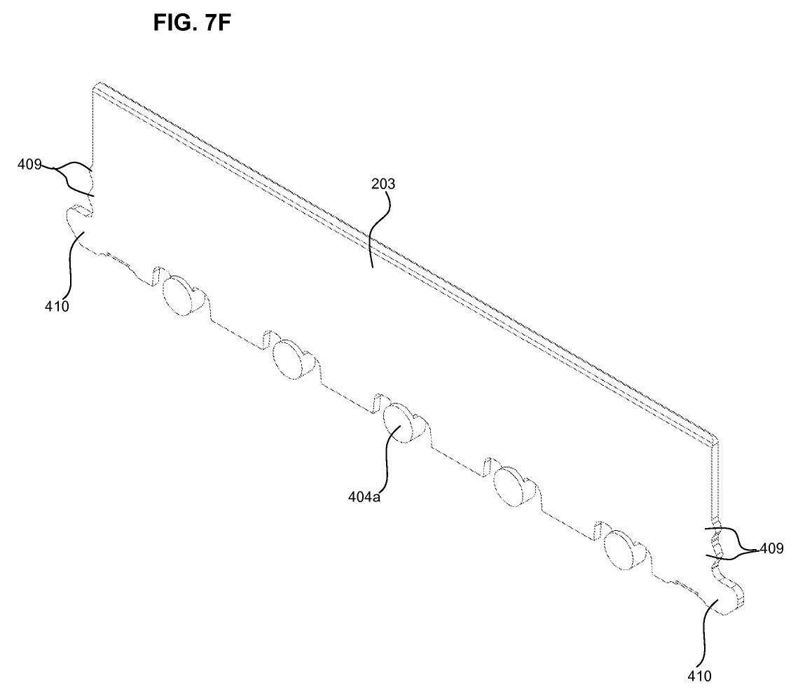

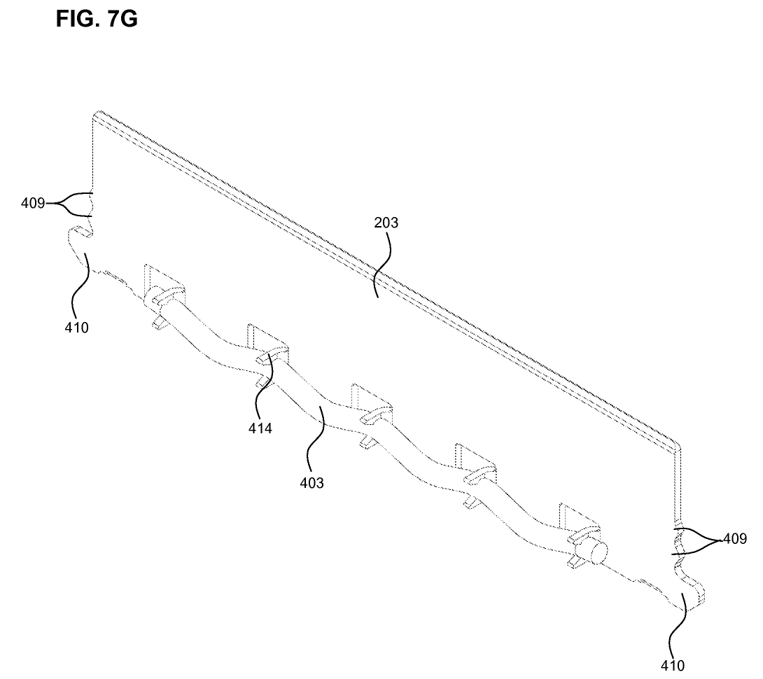

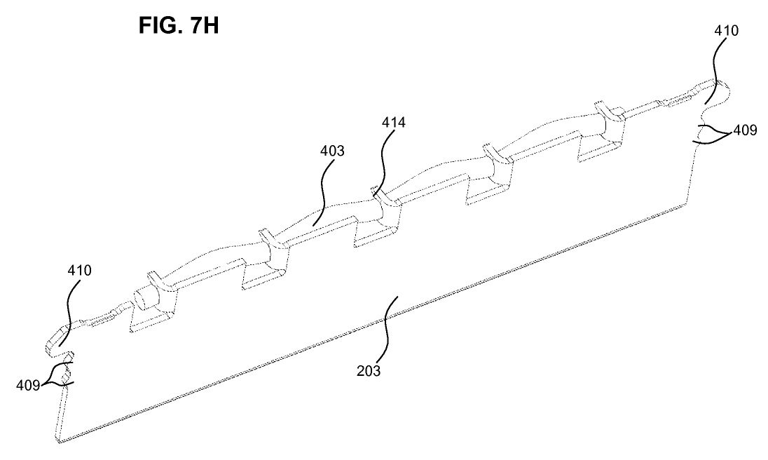

Preferred embodiments of the present invention will be discussed with respect to FIGS. 1A-7H. FIGS. 1A-1D show a female connector 100 according to a preferred embodiment of the present invention. FIGS. 2A-2D show a male connector 200 according to a preferred embodiment of the present invention. FIGS. 3A-3C show cross-sections of the female connector 100 and the male connector 200 mated with one another according to preferred embodiments of the present invention. FIGS. 4A-4E show footprints of printed circuit boards 300a, 300b, 300c, 300d, 300e according to preferred embodiments of the present invention. FIGS. 5A and 5B show bottom views of a female connector 100 and a male connector 200, respectively, according to preferred embodiments of the present invention. FIG. 5C is a sectional view of the female connector 200 according to a preferred embodiment of the present invention. FIGS. 6A and 6B show top and bottom perspective views, respectively, of a female connector 100, and FIGS. 6C and 6D show top and bottom perspective views, respectively, of a male connector 200. FIGS. 7A-7H show ground planes 203 according to preferred embodiments of the present invention.

FIGS. 1A-1D show a female connector 100 according to a preferred embodiment of the present invention. Female connector 100 includes contacts 102 and ground planes 103 disposed in a connector body 101. The connector body 101 preferably has a substantially rectangular shape. However, the connector body 101 can have any other suitable shape. The connector body 101 can be made of any suitable non-conductive material, such as a plastic, an elastomer, an FR-4 material that is typically used for printed circuit boards, or a thermal set material.

The contacts 102 are preferably arranged in two rows of contacts 106a, 106b as shown in FIGS. 1A-1D. However, the contacts 102 can be arranged in additional rows of contacts. Each of the rows of contacts 106a, 106b is preferably divided into two banks 106a1, 106a2 and 106b1, 106b2, respectively. However, the rows of contacts 102 can be arranged in a single bank of contacts or can be arranged in three or more banks of contacts. The number of contacts 102 used in the female connector 100 will depend upon the application. The contacts 102 typically include a copper, copper alloy, or BeCu alloy base upon which conductive layer or layers can be added. The conductive layers typically include tin, nickel, gold, and silver. Other suitable conductive materials can be used for the base and the conductive layers.

The connector 100 preferably includes alignment pins 104 to ensure that the connector 100 is properly aligned with a printed circuit board (not shown in FIGS. 1A-1D, but shown as reference numbers 300a, 300b, 300c, 300d, 300e in FIGS. 4A-4E) when the connector 100 is attached to the printed circuit board. It is possible to use any number of alignment pins. Any other suitable alignment technique can also be used. It is also possible not to use any alignment technique. However, greater care must be used to ensure that the connector 100 is properly aligned.

For each bank of contacts 106a1, 106a2, 106b1, 106b2, a ground plane 103 is arranged to oppose the bank of contacts 106a1, 106a2, 106b1, 106b2. As seen in FIGS. 1A, 1B, and 1D, the ground plane 103 preferably includes a plurality of tongues 103a that extend in the same direction from the ground plane 103. Because the plurality of tongues 103a all extend in the same direction, the ground plane 103 only mates with one side of the ground plane 203 when the female connector 100 and the male connector 200 are mated. The plurality of tongues 103a in opposing banks work in cooperation such that no net torque is generated when the female connector 100 and the male 200 connector are mated. The tongues 103a preferably contact the opposite side of the ground plane 203 where the contacts 102, 202 are located to allow for the contacts 102, 202 to be located closer to the ground planes 103, 203.

Although a plurality of tongues 103a are preferably used, it is possible to use a single tongue. However, a plurality of tongues 103a is preferred because it enables easier mating due to the normal force being less and because it ensures that a plurality of electrical paths are created when the female connector 100 and the male 200 connector are mated.

FIGS. 2A-2D show a male connector 200 according to a preferred embodiment of the present invention. Male connector 200 includes contacts 202 and ground planes 203 disposed in a connector body 201. The connector body 201 preferably has a substantially rectangular shape. However, the connector body 201 can have any other suitable shape. The connector body 201 can be made of any suitable non-conductive material, such as a plastic, an elastomer, an FR-4 material that is typically used for printed circuit boards, or a thermal set material.

The contacts 202 are preferably arranged in two rows of contacts 206a, 206b as shown in FIGS. 2A-2D. However, the contacts 202 can be arranged in additional rows of contacts. Each of the rows of contacts 206a, 206b is preferably divided into two banks 206a1, 206a2 and 206b1, 206b2, respectively. However, the rows of contacts 202 can be arranged in a single bank of contacts or can be arranged in three or more banks of contacts. The number of contacts 202 used in the male connector 200 will depend upon the application. The contacts 102 typically include a copper, copper alloy, or BeCu alloy base upon which conductive layer or layers can be added. The conductive layers typically include tin, nickel, gold, and silver. Other suitable conductive materials can be used for the base and the conductive layers.

The connector 200 preferably includes alignment pins 204 to ensure that the connector 200 is properly aligned with a printed circuit board (not shown in FIGS. 2A-2D, but shown as reference numbers 300a, 300b, 300c, 300d, and 300e in FIGS. 4A-4C) when the connector 200 is attached to the printed circuit board. It is possible to use any number of alignment pins. Any other suitable alignment technique can also be used. It is also possible not to use any alignment technique. However, greater care must be used to ensure that the connector 200 is properly aligned.

For each bank of contacts 206a1, 206a2, 206b1, 206b2, a ground plane 203 is arranged to oppose the bank of contacts 206a1, 206a2, 206b1, 206b2. As seen in FIGS. 2A, 2B, and 2D, the ground plane 203 is planar or substantially planar within manufacturing tolerances. The ground planes 203 of the male connector 200 preferably mate with the tongues 103a of a corresponding ground plane 103 of the female connector 100.

The male connector 200 also includes a shroud 207. The shroud 207 is arranged such that, when the male connector 200 is mated with the female connector 100, the shroud 207 shields or protects the mating surfaces of the connectors 100 and 200. This arrangement of the shroud 207 protects the mated connectors 100 and 200 from contaminants, especially in mixed flow and gas environments, and protects the contacts 202 of the connector 200 in an unmated state from being accidently touched or short-circuited. It is possible for the connector 200 not to include a shroud 207 as shown in FIG. 3A. Without a shroud 207, the connector 200 does not provide as much protection as compared to when the connector 200 includes a shroud 207. However, the connector 200 could be made narrower so that a footprint of the connector 200 would be narrower, and the connector 200 could be manufactured cheaper because less material is used to form the connector 200.

The female connector 100 and the male connector 200 are preferably polarized to ensure proper orientation of the female connector 100 and the male connector 200 when they are mated. Preferably, as shown in FIGS. 1A-1D, the female connector 100 includes a polarization corner 105, and as shown in FIGS. 2A-2D, the male connector 200 includes a polarization corner 205. However, any other suitable polarization technique can also be used. For example, instead of using single polarization corners 105, 205, multiple polarization corners can be used. Also, instead of using polarization corners 105, 205, different size polarization posts and corresponding different size polarization holes can be used. It is also possible not to use any polarization technique. However, greater care must be used to ensure that the female connector 100 and the male connector 200 are properly orientated when they are mated if no polarization technique is used.

The arrangement of the contacts 102, 202 and the ground planes 103, 203 can be used to control the impedance of the connector 100, 200 and to provide for return paths for the signals transmitted through the connectors 100, 200. The impedance of high speed signals can be controlled by providing the return path. The distance between each of the contacts 102, 202 and the ground planes 103, 203, the width of the contacts 102, 202, or both are used to determine the impedance.

The contacts 102, 202 can be arranged, for example, from about 0.016 inches to about 0.020 inches, within manufacturing tolerances, away from the ground plane 103, 203. The distance between the contacts 102, 202 and the ground plane 103, 203 is preferably constant over the length of the contact 102, 202. However, contacts 102, 202 having certain geometries, e.g., the bends in the female contact 102, make it impossible to ensure that the distance is constant. It is desirable in this situation to minimize the variation in the distance such that the distance between the contacts 102, 202 and the ground plane 103, 203 is substantially constant over the length of the contact 102, 202, while still ensuring that the female contact 102 makes acceptable mechanical and electrical contact with the male contact 202. Preferably, the size and the shape of each contact 102 is the same or substantially the same within manufacturing tolerances, and the material of each contact 202 is the same or substantially the same within manufacturing tolerances. However, it is possible to use contacts 102, 202 that have different shapes and sizes or that are made of different material. Typically, this is usually avoided because contacts 102, 202 with different physical characteristics usually have different electrical characteristics. Preferably, the contacts 102, 202 use surface mount technology (SMT). However, it is possible to use other suitable types of contacts, e.g., compression contacts or through-hole contacts.

Although it is preferably that each bank of contacts 106a1, 106a2, 106b1, 106b2, 206a1, 206a2, 206b1, 206b2 has the same or substantially the same impedance, it is possible that at least one of the banks 106a1, 106a2, 106b1, 106b2, 206a1, 206a2, 206b1, 206b2 has a different impedance than the others. The banks of contacts 106a1, 106a2, 106b1, 106b2, 206a1, 206a2, 206b1, 206b2 can have different impedances by using one or more of the techniques discussed above to control the impedance.

The width of the connectors 100 or 200 can be reduced because it is not required that the bank of opposing contacts 106a1, 106b1 and 106a2, 106b2 or 206a1, 206b1 and 206a2, 206b2 be spaced far away from each other in order to have acceptable levels of cross-talk between the opposing contacts 102 or 202.

Preferably, the ground plane 103, 203 is soldered along the entire or substantially the entire length of one of its edges. The ability of the ground planes 103, 203 to act as a ground is improved by increasing the number of points that the ground plane 103, 203 is connected to ground in the printed circuit board. The solder can help with the co-planarity of the connector 100, 200 because, as discussed below, the solder can be shaped after the being attached to the connector 100, 200 so that the solder extends the same or substantially the same distance from the connector 100, 200 as the contacts 102, 202. This soldering also lowers the inductance of the ground plane 103, 203, which results in lower EMI (electromagnetic interference). Because the entire edge or substantially the entire edge of the ground plane 103, 203 is soldered, the connector 100, 200 can withstand higher pull and shear forces. It is also possible to only solder a portion of the edge of the ground plane 103, 203 or not to solder the ground plane 103, 203 at all.

Different soldering arrangements for the ground plane 203 according to preferred embodiments of the present invention are shown in FIGS. 7A-7H. The ground plane 203 are soldered to a printed circuit board (not shown in FIGS. 7A-7H, but shown as reference number 300a, 300b, 300c, 300d, and 300e in FIGS. 4A-4E, respectively). Each of the sides of the ground planes 203 includes protrusions 409 and a tab 410 that help to retain the ground planes 203 within the male connector 200. The ground planes 203 shown in FIGS. 7A-7H can be used in the male connector 200. However, the same solder arrangements can also be used with the ground plane 103 of the female connector 100. Typically, the ground plane 203 and the printed circuit board, along with the electrical connector in which the ground plane 203 is located and various other components and devices, are placed in a reflow oven that causes the solder to reflow. The reflow of solder causes a mechanical and an electrical connection to be formed between the ground plane 203 and the printed circuit board.

FIGS. 7A-7C, 7G, and 7H show perspectives views of a ground plane 203 according to preferred embodiments of the present invention which use a solder rope arrangement. FIGS. 7A and 7B show front and back perspective views, respectively, of the ground plane 203 with a solder rope 402. When the solder rope 402 is reflowed, the solder rope 402 reflows along the entire length of the ground plane 203 such that a mechanical and electrical connection between the ground plane 203 and the printed circuit board is formed. Either a plurality of discrete solder joints, e.g. six or seven solder joints, are formed, or a single, continuous solder joint is formed along the entire or substantially the entire length of the ground plane 203. Because the ground plane 203 is retained within the male connector 200, the male connector 200 is also connected to the printed circuit board. Preferably, the solder arrangements with solder rope 402 are used with the footprints shown in FIGS. 4A-4E with extended ground pads 303. The solder rope 402 is preferably soldered to the entire length or substantially the entire length of the ground pads 303. Because the entire length of the solder rope 402 is soldered to the ground pads 303, a strong mechanical connection is formed between the ground plane 203 and the printed circuit board.

The solder rope 402 is preferably held in place by arms 411 and 412. The arms 411 and 412 are preferably formed by a progressive stamping die. Typically, the grooves on either side of the arms 411 are stamped out, and then the shape of the arm 411 is formed. It is possible for the arms 411 and 412 to be formed at the same time. The arms 411 preferably extend around solder rope 402 to grip the outside of the solder rope 402. The arms 412 preferably grip the inside of the solder rope 402. That is, the solder rope 402 is gripped by both of the arms 411 and 412. Preferably, the arms 411 and 412 alternate such that an arm 412 is between each adjacent pair of arms 411. However, any arrangement and number of arms 411 and 412 can be used. It is also possible to use only arms 411. It is also possible to use other suitable methods to retain the solder rope 402 such that a solder connection can be formed between the ground plane 203 and the printed circuit board.

FIGS. 7C and 7D show front and back perspective views, respectively, of the ground plane 203 in which the solder rope 402 includes deformations 402a. At predetermined points along the solder rope 402, the solder rope 402 is deformed to form deformations 402a. The deformations 402a are used to help ensure that an acceptable coplanarity is achieved by forming the bottoms of the deformations 402a to be the same or substantially the same distance from the connector 200 (not shown in FIGS. 7C and 7D) as the contacts 202. This formation of the bottom of the deformations 402a is preferably performed after the ground plane 203 is inserted in the connector 200. The solder rope 402 can be deformed either after the solder rope 402 is attached to the ground plane 203 or before the solder rope 402 is attached to the ground planes 203.

FIGS. 7G and 7H show top and bottom perspective views, respectively, of the ground plane 203 according to a preferred embodiment of the present invention. A solder rope 403 is held by horizontal arms 414 formed in the ground plane 203. The horizontal arms 414 are preferably formed by progressive stamping. In this preferred embodiment, the solder rope 403 undulates such that, when the ground plane 203 is placed on a printed circuit board, the portion of the solder rope 403 held by the horizontal arms 413 is located above the printed circuit board and a portion of the solder rope 403 between the horizontal arms 414 contacts the printed circuit board.

FIGS. 7E and 7F show perspectives views of a ground plane 203 according to a preferred embodiment of the present invention which uses a crimped solder arrangement. First, vertical arms 413 are formed in the ground plane 203, preferably by progressive stamping. Then, as shown in FIG. 7E, solder pieces 404 are inserted into corresponding vertical arms 413 such the solder pieces 404 are held by the corresponding arms 413. Next, as shown in FIG. 7F, the solder pieces 404 are crimped to form crimped solder 404a. Preferably, the solder pieces 404 are crimped by placing the solder pieces between opposing crimping arms that pinch the solder pieces 404 such that the solder pieces 404 are deformed around the vertical arms 413, thus forming the crimped solder 404a. This method is similar to the method of crimping solder to an electrical contact, instead of a ground plane, disclosed in U.S. Pat. Nos. 6,979,238; 6,969,286; 7,052,337; 7,159,312; 7,125,293; and 7,178,232. The ground plane 203 of this preferred embodiment is preferably used with the footprint shown in FIG. 4D where the crimped solder 404a is aligned with protrusions 303a of the ground pad 303. However, it is also possible use the ground plane 203 of this preferred embodiment with the footprints shown in FIGS. 4A-4C and 4E or with a footprint in which the ground pad 303 is split into a plurality of ground pads (not shown). It is preferably that the solder paste is applied to the ground pad 303 so that the portion of the ground plane 203 without the crimped solder 404a is also soldered. If solder paste is not applied to the ground pad 303, then the crimped solder arrangement does not form as strong of a mechanical connection between the ground plane 203 and the printed circuit board as the solder rope arrangements because the crimped solder arrangement uses less solder.

Either single-ended or differentially paired signals can be transmitted through the contacts 102, 202 of the connector 100, 200. Although not necessary, instead of having signals transmitted through the contacts 102, 202, some of the contacts 102, 202 can be grounded to reduce cross talk between the contacts 102, 202. For example, some of the contacts 102, 202 can be used for differentially paired signals, and some of the contacts 102, 202 can be used for single-ended signals. The arrangement and types of signals transmitted through the connector 100, 200 will depend upon the application.

Instead of grounding some of the contacts 102, 202, the contacts 102, 202 can be removed from the connector 100, 200 (or never included in the connector 100) so that adjacent contacts 102, 202 are sufficiently spaced apart such that the cross-talk between adjacent contacts 102, 202 is substantially reduced. Some of the benefits of this technique of removing contacts 102, 202 is that there is no need to route the contact 102, 202 to ground on a printed circuit board (not shown in FIGS. 1A-1D or 2A-2D), that the signal integrity can be improved, and that custom connectors can be more easily manufactured. This technique can be used with either single-ended or differentially paired signals.

Instead of using the technique of removing contacts 102, 202, it is also possible to design the connectors 100, 200 such that the contacts 102, 202 are spaced far enough apart such that cross-talk is kept at acceptable levels. This technique of spacing the contacts 102, 202 can be used for either single-ended signals or differentially paired signals. With single-ended signals, the spacing is usually designed to be the same or substantially the same with manufacturing tolerances. With differentially paired signals, the contacts 102, 202 are usually grouped into pairs such that the contacts 102, 202 in each pair are closer to each other than any other contact 102, 202.

Preferably, the female connector 100 includes slots 108 in the connector body 101, and the male connector 200 includes protrusions 208 extending from the connector body 201. The slots 108 and the protrusions 208 are arranged, respectively, at opposing ends of the connector body 101 and 201 to be mated and unmated with each other. It is also possible, if the connectors have banks of contacts along the length of the contacts, to locate the slots 108 and protrusions 208 in the middle or the approximate middle of connectors 100, 200 between the banks of contacts. The protrusions 208 preferably include chamfered sides. The chamfered sides of the protrusions 208 allow the female connector 100 and the male connector 200 to be zippered together, i.e., to be easily mated and unmated, even when an unequal force is used. It is also possible not to use the slots 108 and protrusions 208 at all. However, in such a case, greater care must be taken to mate and unmate the connectors 100 and 200.

FIGS. 3A-3C and 5A-6D show additional preferred embodiments of the present invention in which similar elements are labeled with the same reference number as used in FIGS. 1A-2D. The additional preferred embodiments shown in FIGS. 3A-3C and 5A-6D include features that can be used alone or in combination with each other.

In FIG. 3A, the connectors 100, 200 are arranged in a similar manner as the female connector 100 shown in FIGS. 1A-1D and the male connector 200 shown in FIGS. 2A-2D, except that the contacts 102, 102 and the ground planes 103, 203 are reversed. This arrangement of the contacts 102, 102 and the ground planes 103, 203 allows for easier routing on the printed circuit board and allows for the ground planes 103, 203 to provide electromagnetic interference (EMI) shielding. As discussed above, the male connector 200 also does not include a shroud 207.

FIGS. 3B and 6A-6D show preferred embodiments of the present invention that include power planes 111, 211. FIGS. 6A and 6B are top and bottom perspective views, respectively, of a female connector 100 having a power plane 111 according to a preferred embodiment of the present invention, and FIGS. 6C and 6D are top and bottom perspective views, respectively, of a male connector 200 having a power plane 211 according to a preferred embodiment of the present invention. FIG. 3B is a cross-sectional view showing the female connector 100 and the male connector 200 mated to one another and having two power planes 111, 211.

As shown in FIGS. 6A and 6B, the female connector 100 includes a power plane 111 with a plurality of tongues 111a. As shown in FIGS. 6C and 6D, the male connector 200 includes a power plane 211 that is planar or substantially planar within manufacturing tolerances. The tongues 111a of the power plane 111 provide mechanical and electrical contact with the power plane 211 when the female connector 100 and the male connector 200 are mated together. Adjacent tongues 111a alternate sides such that adjacent tongues 111a contact opposite sides of the power plane 111 when the female connector 100 and the male connector 200 are mated together. With this arrangement of the tongues 111a, no net torque is generated when the female connector 100 and the male 200 connector are mated.

As shown in FIGS. 6A-6D, the female connector 100 and the male connector 200 preferably includes two planes 111, 211 arranged in a single row. However, it is possible to use a single power plane 111, 211 or to use multiple power planes 111, 211 arranged in multiples rows as shown in FIG. 3B. When more than one power plane is used, it is possible to provide different power levels on each of the power planes. It is also possible to use one or more of the power planes 111, 211 as an additional ground plane or planes.

FIGS. 6A-6D show an arrangement of the contacts 102, 202 and ground planes 103, 203 in which the ground planes 103, 203 are located on the exterior of the connectors 100, 200. However, this arrangement can be reversed such that the contacts 102, 202 are located on the exterior of the connectors 100, 200. This is just one example in which the features of different preferred embodiments of the present invention can be combined. With the arrangement shown in FIGS. 6A-6D with the contacts 102, 202 located between the ground planes 111, 211 and the ground planes 103, 203, the signals transmitted through the contacts 102, 202 can be referenced to both the ground planes 103, 203 and the ground planes 111, 211. It is possible to use any of the ground planes 103, 111, 203, 211 as a power plane. It is also possible to use different voltages, e.g. 0 V (ground), +2.5 V, −2.5 V, +5 V, −5 V.

In FIG. 3C, the connectors 100, 200 include, respectively, central conductors 120, 220, insulators 121, 221, and conductive sheathes 122, 222 that form a coaxial connector. The central conductors 120, 220, the insulators 121, 221, and the conductive sheathes 122, 222 are preferably arranged such that a coaxial structure is maintained throughout the connectors 100, 200. The feature of the coaxial structures can be also used with the power planes 111, 211 discussed above. For example, in the middle of the connectors 100, 200, the coaxial structures and the power planes 100, 201 can be aligned in a single row or can be aligned in multiple rows.

FIGS. 5A and 5B are bottom perspective views of a female connector 100 and a male 200, respectively, that include capacitors 110 and 210, respectively, according to preferred embodiments of the present invention. The capacitors 110, 210 are preferably respectively connected to the ground planes 103, 203 to improve or manipulate the electrical characteristics of the connectors 100, 200. The capacitors 110, 210 can be attached to the ground planes 103, 203 by any suitable method. For example, as shown in FIG. 5C, the capacitors 110 can be connected to the ground planes 103 by a U-shaped arm 240. The U-shaped arm 240 can be connected to the ground planes 103 by any suitable method. For example, U-shaped arm 240 can be soldered to the ground planes 103 or can be arranged such that the normal forces generated by the legs 240a are sufficient to keep the U-shaped arm 240 connected to the ground planes. Any type of capacitors can be used, as long as the capacitor can fit between the ground planes 103, 203. It is possible to use a plurality of capacitors 110 for each pair of ground planes 103 as shown in FIG. 5A, and it is possible to use a single capacitor 210 for each pair of ground planes 203 as shown in FIG. 5B. The capacitors 210 can also be used with the female connector 100, and the capacitors 110 can also be used with the male connector 200. It is also possible to add other electronic components, either active or passive, to the connectors 100, 200 to control or to manipulate the electrical characteristics transmitted through the connectors 100, 200. The capacitors 110, 210 can be attached to the connectors 100, 200 before being attached to a printed circuit board (not shown in FIGS. 5A and 5B). Or, as shown in FIGS. 4B and 4C, the capacitors 305a, 305b can be placed on the printed circuit board 300b, 300c so that the capacitors 305a, 305b are connected to the ground planes 103, 203 either before the connectors 100, 200 are connected to the printed circuit board 300b, 300c or at the same time that the connectors 100, 200 are connected to the printed circuit board 300b, 300c.

FIGS. 4A-4E show various top plan views of printed circuit boards 300a, 300b, 300c, 300d, 300e, respectively, according to preferred embodiments of the present invention. FIG. 4A shows the footprint of a printed circuit board 300a used when connecting the connectors 100, 200 to the printed circuit board 300a. The footprint includes a plurality of contact pads 302 and a plurality of ground pads 303. The contact pads 302 and the ground pads 303 are arranged to align with the contacts 102, 202 and the ground planes 103, 203 of the female connector 100 or the male connector 200 when the female connector 100 or the male connector 200 is attached to the printed circuit board 300a.

The contact pads 302 are preferably arranged in two rows of contact pads 306a, 306b. However, the contact pads 302 can be arranged in additional rows of contact pads. Each of the rows of contact pads 306a, 306b is preferably divided into two banks 306a1, 306a2 and 306b1, 306b2, respectively. However, the rows of contact pads 302 can be arranged in a single bank of contact pads or can be arranged in three or more banks of contact pads. The number of contact pads 302 used in the footprint will depend upon the application.

The printed circuit board 300a preferably includes alignment holes 304 for engaging the alignment pins 104, 204 of the connectors 100, 200 when the connectors 100, 200 are attached to the printed circuit board 300a. It is possible to use any number of alignment holes. It is preferable that different arrangements of alignment holes 304 be used for the female connector 100 and for the male connector 200. Any other suitable alignment technique can also be used. It is also possible not to use any alignment technique. However, greater care must be used to ensure that the connectors 100, 200 are properly aligned with respect to the printed circuit board 300.

For each bank of contact pads 306a1, 306a2, 306b1, 306b2, a ground pad 303 is arranged to oppose the bank of contacts pads 306a1, 306a2, 306b1, 306b2. The ground pad 303 of the printed circuit board 300 is soldered to a corresponding ground plane 103, 203 of the connectors 100, 200.

FIGS. 4B and 4C show printed circuit boards 300b, 300c having footprints according to preferred embodiments of the present invention. As with printed circuit board 300a, the printed circuit boards 300b, 300c includes contact pads 302 that are preferably arranged into rows 306a, 306b that are divided into banks 306a1, 306a2, 306b1, 306b2. The printed circuit boards 300b, 300c further also include capacitors 305a, 305b. The printed circuit board 300b shown in FIG. 4B includes a plurality of capacitors 305b arranged between the ground pads 303 between banks 306a1, 306b1 and between banks 306a2, 306b2. The printed circuit board 300c shown in FIG. 4C includes a single capacitor 305b arranged between banks 306a1, 306b1 and between banks 306a2, 306b2. Any type and number of capacitors can be used between the between banks 306a1, 306b1 and between the banks 306a2, 306b2.

FIG. 4D shows a printed circuit board 300d having a footprint according to a preferred embodiment of the present invention in which the ground pads 303 include protrusions 303a. The protrusions 303a are arranged to be aligned with the crimped solder 404a shown in FIGS. 7E and 7F.

FIGS. 4A-4D show printed circuit boards 300a, 300b, 300c, 300d with footprints that can be used with the connectors 100, 200 shown in FIGS. 1A-2D, 5A, and 5B in which the contacts 103, 203 are arranged on the outside of the connector and the ground planes 103, 203 are arranged in the interior of the connector. Printed circuit boards having different footprints can be used with different preferred embodiments of the present invention. For example, as shown in FIG. 4E, the ground pads 303 can be located outside of the contact pads 302.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. An electrical connector comprising:
a first row of contacts extending in a first direction;
a second row of contacts extending in the first direction;
a first ground plane extending in the first direction;
a second ground plane extending in the first direction; wherein
the first row of contacts is located closer to the first ground plane than any other ground plane in the electrical connector;
the second row of contacts is located closer to the second ground plane than any other ground plane in the electrical connector; and
the first row of contacts, the second row of contacts, the first ground plane, and the second ground plane oppose each other such that the first row of contacts, the second row of contacts, the first ground plane, and the second ground plane are arranged with respect to each other in a second direction perpendicular or substantially perpendicular to the first direction.

2. The electrical connector according to claim 1, further comprising a shroud that is arranged to surround an interface between the electrical connector and another electrical connector when the electrical connector is mated with the another electrical connector.

3. The electrical connector according to claim 1, further comprising at least one electronic component.

4. The electrical connector according to claim 1, further comprising at least one capacitor connected between the first ground plane and the second ground plane.

5. The electrical connector according to claim 1, further comprising at least one power plane.

6. The electrical connector according to claim 1, further comprising a first power plane and a second power plane; wherein
power with a first voltage is transmitted through the first power plane; and
power with a second voltage, different from the first voltage, is transmitted through the second power plane.

7. The electrical connector according to claim 1, further comprising a coaxial connector.

8. The electrical connector according to claim 1, wherein each of the first ground plane and the second ground plane includes at least one tongue that is arranged to make a mechanical connection and an electrical connection with a corresponding ground plane of another electrical connector when the electrical connector is mated with the another electrical connector.

9. The electrical connector according to claim 1, wherein the first row of contacts and the second row of contacts are spaced apart from the first ground plane and the second ground plane, respectively, by about 0.016 inches to about 0.020 inches.

10. The electrical connector according to claim 1, wherein:
the first row of contacts is located between the first ground plane and an exterior of the electrical connector; and
the second row of contacts is located between the second ground plane and the exterior of the electrical connector.

11. The electrical connector according to claim 1, wherein:
the first ground plane is located between the first row of contacts and an exterior of the electrical connector; and
the second ground plane is located between the second row of contacts and the exterior of the electrical connector.

12. The electrical connector according to claim 1, wherein:
each of the first row of contacts and the second rows of contacts includes a first bank of contacts and a second bank of contacts; and
each of the first and the second ground planes includes a first divided ground plane and a second divided ground plane.

13. The electrical connector according to claim 1, further comprising at least one chamfered protrusion that is arranged to engage with a slot of another connector so that the electrical connector zippers with the another electrical connector when the electrical connector is mated with the another electrical connector.

14. The electrical connector according to claim 1, further comprising a slot that is arranged to engage with at least one chamfered protrusion of another connector so that the electrical connector zippers with the another electrical connector when the electrical connector is mated with the another electrical connector.

15. A circuit board comprising:
a first row of contact pads that extends in a first direction and that is arranged to be connected to corresponding first row of contacts of an electrical connector;
a second row of contact pads that extends in the first direction and that is arranged to be connected to corresponding second row of contacts of an electrical connector;
a first ground plane pad that continuously extends in the first direction along the first row of contacts pads and that is arranged to be connected to a corresponding first ground plane of an electrical connector; and
a second ground plane pad that continuously extends in the first direction along the second row of contacts pads and that is arranged to be connected to a corresponding second ground plane of an electrical connector; wherein
the first row of contact pads is located closer to the first ground plane pad than any other ground plane pad in the circuit board;
the second row of contact pads is located closer to the second ground plane pad than any other ground plane pad in the circuit board; and
the first row of contact pads, the second row of contact pads, the first ground plane pad, and the second ground plane pad oppose each other such that the first row of contact pads, the second row of contact pads, the first ground plane pad, and the second ground plane pad are arranged with respect to each other in a second direction perpendicular or substantially perpendicular to the first direction.

16. The circuit board according to claim 15, further comprising at least power plane pad that continuously extends in the first direction and that is arranged to be connected to a corresponding power plane of an electrical connector.

17. The circuit board according to claim 15, further comprising at least one coaxial connector that is arranged to be connected to corresponding at least one coaxial connector of an electrical connector.

18. The circuit board according to claim 15, wherein the first row of contact pads and the second row of contact pads are spaced apart from the first ground plane and the second ground plane, respectively, by about 0.016 inches to about 0.020 inches.

19. The circuit board according to claim 15, wherein:
the first ground plane pad is located between the first row of contact pads and the second row of contact pads; and
the second ground plane pad is located between the first row of contact pads and the second row of contact pads.

20. The circuit board according to claim 15, wherein:
each of the first row of contact pads and the second rows of contact pads includes a first bank of contact pads and a second bank of contact pads; and
each of the first ground plane pad and the second ground plane pad includes a first divided ground plane pad and a second divided ground plane pad.
